(19) United States
(12) Patent Application Publication
(10) Pub. No.: US 2010/0186632 A1
(43) Pub. Date: Jul. 29, 2010

(54) Method of manufacturing a rock slurry

(76) Inventors: Shinji Ito, Tokyo (JP); Mayuko Ishida, Tokyo (JP); Kiyoshi Kanamura, Tokyo (JP)

Correspondence Address: SEED INTELLECTUAL PROPERTY LAW GROUP PLLC, 701 FIFTH AVE, SUITE 5400, SEATTLE, WA, 98104, US

(21) Appl. No.: 12/657,493

(22) Filed: Jan. 20, 2010

Related U.S. Application Data
(60) Provisional application No. 61/205,520, filed on Jan. 20, 2009.

(51) Int. Cl. C04B 14/02

(52) U.S. Cl. 106/401

(57) ABSTRACT

A rock slurry having a negative oxidation reduction potential, including a Bakuhan-seki rock slurry having a negative oxidation reduction potential may be manufactured or processed using granite porphyry or quartz porphyry. A resulting product may be useful in medical, health, and/or cosmetic applications.

### CROSS-REFERENCE TO RELATED APPLICATION

This application claims the benefit under 35 U.S.C. §119(e) of U.S. Provisional Patent Application No. 61/205,520 filed Jan. 20, 2009; where this provisional application is incorporated herein by reference in its entirety.

### BACKGROUND

1. Field

This disclosure generally relates to manufacturing a rock slurry. In particular, this disclosure relates to a method of manufacturing a rock slurry having a negative oxidation reduction potential, including a Bakuhan-seki rock slurry having a negative oxidation reduction potential manufactured using granite porphyry or quartz porphyry.

2. Description of the Related Art

“Bakuhan-seki” is a descriptive Japanese language compound word composed of “Bakuhan,” meaning rice cooked with barley, and “seki,” meaning rock or stone. Bakuhan-seki generally refers to igneous rock whose external appearance visually resembles cooked rice with added barley. The portion that resembles “rice” in appearance may contain a finely grained groundmass, while the portion that resembles “barley” in appearance may contain coarser crystals as phenocrysts.

Bakuhan-seki as used herein generally refers to porphyry rock, including granite porphyry and quartz porphyry. Porphyries contain rare earth elements that have shown to be useful in medical, health, and cosmetic applications.

### BRIEF SUMMARY

A method of manufacturing a rock slurry having a negative oxidation reduction potential, may be summarized as comprising: placing porphyry into a milling chamber of a milling apparatus; adding a liquid to the milling chamber, substantially replacing air within the milling chamber with the liquid; starting the milling apparatus; and adding a liquid to the milling chamber when the average particle size of the porphyry is substantially equal to or less than one-half of a desired final average particle size, substantially replacing air within the milling chamber with the liquid.

A method of manufacturing a rock slurry having a negative oxidation reduction potential, may be summarized as comprising: placing porphyry into a milling chamber of a milling apparatus; adding a liquid to the milling chamber, substantially replacing air within the milling chamber with the liquid; starting the milling apparatus; and stopping the milling apparatus when an average particle size of the porphyry is substantially equal to or less than one-half of a desired final average particle size; adding a liquid to the milling chamber while the milling apparatus is stopped, substantially replacing air within the milling chamber with the liquid; and restarting the milling apparatus.

The milling apparatus may be a ball mill apparatus comprising a milling ball. The milling ball may comprise a ceramic.

A method of manufacturing a rock slurry having a negative oxidation reduction potential, may be summarized as comprising: providing porphyry to a milling chamber of a milling apparatus; substantially replacing air within the milling chamber holding the provided porphyry with a first volume of a liquid; milling the porphyry; and further substantially replacing air within the milling chamber holding at least partially milled porphyry with a second volume of a liquid when an average particle size of the porphyry is substantially equal to or less than one-half of a desired final average particle size while continuously milling the porphyry. Milling the porphyry may include milling the porphyry with a milling ball. Milling the porphyry may include milling the porphyry with a ceramic milling ball.

A method of manufacturing a rock slurry having a negative oxidation reduction potential, may be summarized as comprising: providing a quantity of porphyry to a milling chamber of a milling apparatus; substantially replacing air within the milling chamber holding the provided porphyry with a liquid; partially milling the porphyry; stopping the partial milling of the porphyry when an average particle size of the partially milled porphyry is substantially equal to or less than one-half of a desired final average particle size; further substantially replacing air within the milling chamber holding the partially milled porphyry with a liquid while the milling of the porphyry is stopped; and further milling the porphyry after the further substantially replacing of air with the milling chamber with the liquid. Milling the porphyry may include milling the porphyry with a milling ball. Milling the porphyry may include milling the porphyry with a ceramic milling ball.

A product may be summarized as a product produced by milling porphyry with air substantially replaced by a liquid.

### BRIEF DESCRIPTION OF THE SEVERAL VIEWS OF THE DRAWINGS

The patent or application file contains at least one drawing executed in color. Copies of this patent or patent application publication with color drawings will be provided by the Office upon request and payment of the necessary fee.

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a diagram illustrating a difference between an oxidation reduction potential of a slurry obtained by milling a rock in a substantially gas free environment and an oxidation reduction potential of a slurry obtained by milling a rock in an environment containing a gas.

FIG. 2 is a diagram illustrating a difference between an oxidation reduction potential of a slurry obtained by continuous milling in an environment containing a gas and an oxidation reduction potential of a slurry obtained by milling in a substantially gas free environment.

FIG. 3 is a photograph of a rock used in an experiment.

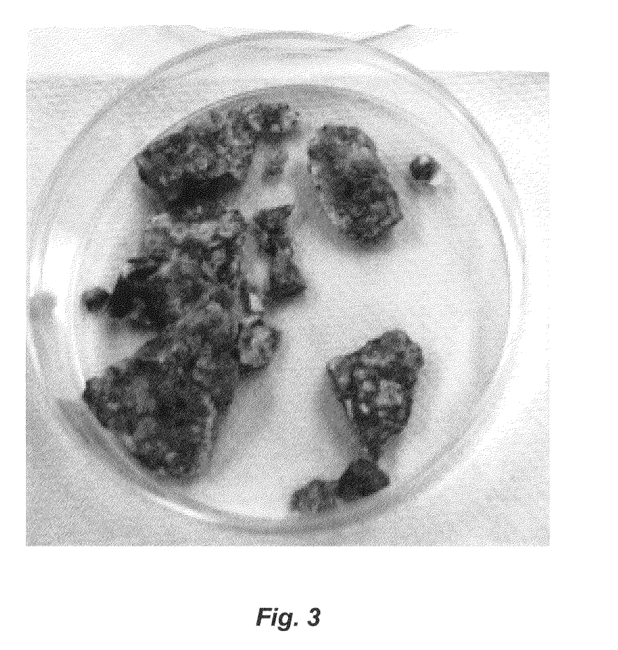

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with milling, slurry handling and fluid flow, such as valves and conduits have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is, as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

“Rock” as used herein means a rock capable of being used to produce a slurry having a negative oxidation reduction potential when. Examples thereof include granite porphyry, quartz porphyry, diorite porphyrite, monzonite porphyry, and Bakuhan-seki. One or more rocks may be used in slurry preparation. Further, other materials may be used in slurry preparation provided that the slurry prepared has a negative oxidation reduction potential.

“Oxidation reduction potential” as used herein refers to a potential generated when giving or receiving electrons in an oxidation-reduction reaction system, and is a scale for quantitatively evaluating the ease of releasing or receiving electrons.

Note that oxidation reduction potential measurements were obtained using a silver-silver chloride electrode as a reference electrode.

“Milling apparatus” as used herein means an apparatus which has a sealed milling chamber capable of being used to mill a rock within a liquid. A non-limiting example of a milling apparatus is a mill.

“Negative oxidation reduction potential” as used herein means a negative value of an oxidation reduction potential of a rock slurry measured immediately after the rock slurry has been prepared.

“Liquid” as used herein means a fluidic substance that has a certain volume at room temperature under ordinary pressure, but does not have a defined shape. Liquids are not limited provided that a rock slurry produced has a negative oxidation reduction potential. Examples of suitable liquids include water, buffers, organic solvents, and mixtures thereof. Further, an additive such as an antiseptic may be added to the liquid.

“Substantially gas free environment” as used herein means that the ratio of the volume of gas to the volume of a space holding the gas is 0.5% or less.

“Desired average particle size” as used herein referring to a rock slurry may be determined depending on the intended use of the rock slurry. Average particle size may be measured by using a particle size distribution measurement apparatus.

Specific examples are described below to provide more detail to the disclosure. The disclosure is not, however, limited the content shown in the examples.

It may be preferable that all parts of a milling apparatus used in preparing a rock slurry, and which come into contact with the rock slurry, be substantially free of heavy metals if the rock slurry is to be used in contact with the human body. In one or more embodiments, a ball mill may be used as a milling apparatus and a ball used in the ball mill may be made from a ceramic material. Examples of ceramic materials include alumina and zirconia.

### Example 1

60 kg of granite porphyry particles from about 0.5 mm to 1.5 mm, and 40 kg of deionized water were prepared.

150 kg of alumina milling balls (φ10 mm: 120 kg, φ20 mm: 15 kg, φ30 mm: 15 kg, manufactured by HIRA CERAMICS CO., LTD.) were loaded into a 50 kg ball mill (manufactured by Sato Kikai Kogyosho Limited Partnership Company) having an alumina intermediate plate.

The granite porphyry was then added to the mill. The total 60 kg mass of granite porphyry could not be loaded initially because spaces formed between particles of the granite porphyry. Portions of the granite porphyry and deionized water were therefore alternately loaded into the mill, and at the point when the mill was full, a cover provided on the mill was closed. The mill was then run in preliminary operation for about 3 minutes.

Next, the cover of the ball mill was opened, more of the granite porphyry and the deionized water were loaded into the mill, the cover was closed, and the mill was again run in preliminary operation. Operation, stoppage, loading, and further operation procedures were repeated until substantially all of the prepared granite porphyry and deionized water were loaded into the mill. Before starting main operation, excess deionized water was added to the mill until it overflowed the mill and spilled out when the cover was closed, thus removing substantially all gas remaining in the mill. The ball mill was then operated for 24 hours at 57 rpm.

When the ball mill cover was opened after 24 hours, gas was found to be present inside the mill, so additional deionized water (about 2 kg) was added into the mill to fill the space occupied by, and thus remove, the gas. The mill was then operated for 70 hours in total, and the resulting slurry was collected.

### Example 2

60 kg of granite porphyry particles from about 0.5 mm to 1.5 mm, and 40 kg of deionized water were prepared.

300 kg of alumina milling balls (φ10 mm: 200 kg, φ15 mm: 50 kg, φ20 mm: 50 kg) were loaded into a 200 kg ball mill, larger than that used in Example 1.

Preliminary operation was then performed for several minutes, after which a gas (air) layer was replaced with nitrogen. Milling was then performed until the resultant granite porphyry particles were found to have substantially the same particle size distribution as those of Example 1, and the resulting slurry was collected.

### Example 3

A particle size distribution measurement apparatus (Microtrac MT 3000II, manufactured by Nikkiso Co., Ltd.) was supplied with the slurries obtained in Example 1 and Example 2. Particle sizes was measured under the following conditions:

Solvent: water

Solvent refractive index: 1.333

Refractive index: 1.81

Distribution display: volume

Particle transparency: transparent

Particle form: non-spherical

Number of measurements: 2 (an average particle size of the two measurements was used)

Time period for measurement: 30 seconds

Sample treatment: integrated ultrasonics (40 W) for 3 minutes

Further, an oxidation reduction potential for each of the obtained slurries was measured by connecting a type 9300-10D ORP electrode, manufactured by HORIBA, Ltd., to a type D-52 pH/ORP meter, manufactured by HORIBA, Ltd. The specific method used involves filling a bottle made of polypropylene with each of the slurries and inserting the ORP electrode into the slurry. Any slurry that overflowed the bottle was wiped off. The bottle is tightly stopped while measurement is taking place to substantially avoid air entering the bottle. Measurement was performed at intervals of 1 to 10 minutes.

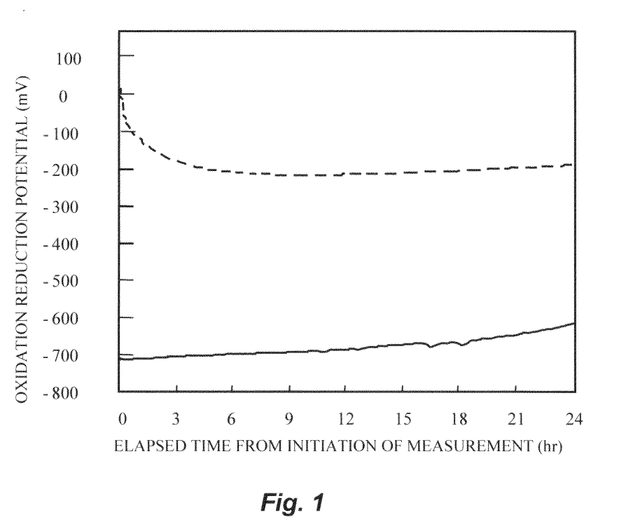

The results of the particle size distribution measurement are shown in Table 1 and changes in the oxidation reduction potentials over time period are shown in FIG. 1.

In FIG. 1, the solid line represents an oxidation reduction potential of a slurry prepared in a substantially gas free environment, while the broken line represents an oxidation reduction potential of a slurry prepared in an environment containing a gas. The ordinate represents oxidation reduction potential (mV) and the abscissa represents elapsed time from initiation of measurement.

TABLE 1

| | 10% particle size | 50% particle size | 95% particle size |
|---|---|---|---|
| | (μm) | (μm) | (μm) |
| Example 1 | 1.418 | 2.403 | 4.495 |
| Example 2 | 0.953 | 2.036 | 4.300 |

Slurries having substantially the same particle size distribution are obtained as shown in Table 1. However, FIG. 1 shows that the oxidation reduction potential of the slurry prepared in an environment containing a gas did not drop lower than about −200 mV.

### Example 4

45 kg of granite porphyry particles from about 0.5 mm to 1.5 mm, and 51 kg of deionized water were prepared.

150 kg of alumina milling balls (φ10 mm: 120 kg, φ20 mm: 15 kg, φ30 mm: 15 kg, manufactured by HIRA CERAMICS CO., LTD.) were loaded into a 50 kg ball mill (manufactured by Sato Kikai Kogyosho Limited Partnership Company) having an alumina intermediate plate.

The granite porphyry was then added to the mill. The total 45 kg mass of granite porphyry could not be loaded initially because spaces formed between particles of the granite porphyry. Portions of the granite porphyry and deionized water were therefore alternately loaded into the mill, and at the point when the mill was full, a cover provided on the mill was closed. The mill was then run in preliminary operation for about 3 minutes.

Next, the cover of the ball mill was opened, more of the granite porphyry and the deionized water were loaded into the mill, the cover was closed, and the mill was again run in preliminary operation. Operation, stoppage, loading, and further operation procedures were repeated until substantially all of the prepared granite porphyry and deionized water were loaded into the mill. Before starting main operation, excess deionized water was added to the mill until it overflowed the mill and spilled out when the cover was closed, thus removing substantially all gas remaining in the mill. The ball mill was then operated for 26 hours at 57 rpm.

When the ball mill cover was opened after 26 hours, gas was found to be present inside the mill, so additional deionized water (about 2 kg) was added into the mill to fill the space occupied by, and thus remove, the gas. The mill was then operated for 43 hours in total, and the resulting slurry was collected.

### Example 5

45 kg of granite porphyry particles from about 0.5 mm to 1.5 mm, and 35 kg of deionized water were prepared.

180 kg of alumina milling balls (φ10 mm: 150 kg, φ20 mm: 15 kg, φ30 mm: 15 kg, manufactured by HIRA CERAMICS CO., LTD.) were loaded into a 50 kg ball mill (manufactured by Sato Kikai Kogyosho Limited Partnership Company) having an alumina intermediate plate.

The granite porphyry was then added to the mill. The total 45 kg mass of granite porphyry could not be loaded initially because spaces formed between particles of the granite porphyry. Portions of the granite porphyry and deionized water were therefore alternately loaded into the mill, and at the point when the mill was full, a cover provided on the mill was closed. The mill was then run in preliminary operation for about 3 minutes.

Next, the cover of the ball mill was opened, more of the granite porphyry and the deionized water were loaded into the mill, the cover was closed, and the mill was again run in preliminary operation. Operation, stoppage, loading, and further operation procedures were repeated until substantially all of the prepared granite porphyry and deionized water were loaded into the mill. Before starting main operation, excess deionized water was added to the mill until it overflowed the mill and spilled out when the cover was closed, thus removing substantially all gas remaining in the mill. The ball mill was then operated for 48 hours at 57 rpm without adding additional ion exchange water during operation. The resulting slurry was then collected, and gas was found present inside the mill.

### Example 6

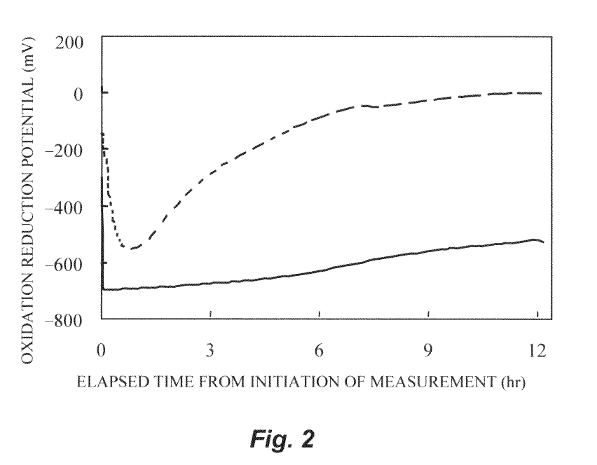

Particle size distribution measurements and oxidation reduction potential measurements of the slurries obtained in Example 4 and Example 5 were performed using the same methods as used in Example 3. Results of the particle size distribution measurement are shown in Table 2 and changes in the oxidation reduction potentials are shown in FIG. 2.

In FIG. 2, the solid line represents an oxidation reduction potential of a slurry prepared in a substantially gas free environment, while the broken line represents an oxidation reduction potential of a slurry prepared in an environment containing a gas. The ordinate represents oxidation reduction potential (mV) and the abscissa represents elapsed time from initiation of measurement.

TABLE 2

| | 10% particle size | 50% particle size | 95% particle size |
|---|---|---|---|
| Sample | (μm) | (μm) | (μm) |
| Example 4 | 1.486 | 2.575 | 5.099 |
| Example 5 | 1.620 | 2.972 | 5.498 |

Slurries having substantially the same particle size distribution are obtained as shown in Table 2. However, FIG. 2 shows the following results regarding oxidation reduction potentials. The slurry prepared in Example 5 in an environment containing gas had an initial potential of about −500 mV, but the potential rose thereafter, reaching 0 mV after approximately 12 hours. The Example 5 slurry was not able to maintain a negative oxidation reduction potential. On the other hand, the slurry prepared in Example 4 in a substantially gas free environment due to the addition of deionized water during operation was able to maintain a potential of −500 mV or lower 12 hours after preparation.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to other porphyry processing methods and apparatus, not necessarily the exemplary porphyry milling method and apparatus generally described above.

In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. A method of manufacturing a rock slurry having a negative oxidation reduction potential, the method comprising:
placing porphyry into a milling chamber of a milling apparatus;
substantially replacing air within the milling chamber with a first quantity of liquid;
starting the milling apparatus; and
when the average particle size of the porphyry is substantially equal to or less than one-half of a defined final average particle size, substantially replacing air within the milling chamber with a second quantity of liquid.

2. The method of claim 1, further comprising:
before replacing air within the milling chamber with the second quantity of liquid, stopping the milling apparatus when the average particle size of the porphyry is substantially equal to or less than one-half of the defined final average particle size; and
restarting the milling apparatus after replacing air within the milling chamber with the second quantity of liquid.

3. The method of claim 2 wherein placing porphyry into a milling chamber of a milling apparatus includes placing porphyry into the milling chamber of a ball mill apparatus comprising a milling ball.

4. The method of claim 2, further comprising:
milling the porphyry in the milling chamber with a ceramic milling ball.

5. The method of claim 1 wherein placing porphyry into a milling chamber of a milling apparatus includes placing porphyry into the milling chamber of a ball mill apparatus comprising a milling ball.

6. The method of claim 1, further comprising:
milling the porphyry in the milling chamber with a ceramic milling ball.

7. The method of claims 1 wherein replacing air within the milling chamber with a first quantity of liquid includes adding the first quantity of liquid to the milling chamber.

8. The method of claims 1 wherein replacing air within the milling chamber with a second quantity of liquid includes adding the second quantity of liquid to the milling chamber.

9. The method of claim 1, further comprising:
continuously milling the porphyry while adding the second quantity of liquid to the milling chamber.

10. The method of claim 9 wherein continuously milling the porphyry while adding the second quantity of liquid to the milling chamber includes continuously milling the porphyry with a milling ball.

11. The method of claim 9 wherein continuously milling the porphyry while adding the second quantity of liquid to the milling chamber includes continuously milling the porphyry with a ceramic milling ball.

12. A product produced by a method comprising:
placing porphyry into a milling chamber of a milling apparatus;
substantially replacing air within the milling chamber with a first quantity of liquid;
starting the milling apparatus; and
when the average particle size of the porphyry is substantially equal to or less than one-half of a defined final average particle size, substantially replacing air within the milling chamber with a second quantity of liquid.

13. The product of claim 12 produced by the method further comprising:
before replacing air within the milling chamber with the second quantity of liquid, stopping the milling apparatus when the average particle size of the porphyry is substantially equal to or less than one-half of the defined final average particle size; and
restarting the milling apparatus after replacing air within the milling chamber with the second quantity of liquid.

14. The product of claim 12 wherein placing porphyry into a milling chamber of a milling apparatus includes placing porphyry into the milling chamber of a ball mill apparatus comprising a milling ball.

15. The product of claim 12 produced by the method further comprising:
milling the porphyry in the milling chamber with a ceramic milling ball.

16. The product of claim 12 wherein replacing air within the milling chamber with a first quantity of liquid includes adding the first quantity of liquid to the milling chamber.

17. The product of claim 12 wherein replacing air within the milling chamber with a second quantity of liquid includes adding the second quantity of liquid to the milling chamber.

18. The product of claim 17 produced by the method further comprising:
continuously milling the porphyry while adding the second quantity of liquid to the milling chamber.

19. The product of claim 18 wherein continuously milling the porphyry while adding the second quantity of liquid to the milling chamber includes continuously milling the porphyry with a milling ball.

20. The product of claim 18 wherein continuously milling the porphyry while adding the second quantity of liquid to the milling chamber includes continuously milling the porphyry with a ceramic milling ball.
